(19) United States
(12) Patent Application Publication
(10) Pub. No.: US 2024/0017976 A1
(43) Pub. Date: Jan. 18, 2024

(54) ADVANCED MATERIAL HANDLING VEHICLE

(71) Applicant: Toyota Material Handling, Inc., Columbus, IN (US)

(72) Inventors: Mustafa Parlaktuna, Indianapolis, IN (US); Robert Eric Relyea, Columbus, IN (US); Anthony Brian Simpson, Columbus, IN (US)

(21) Appl. No.: 18/352,839

(22) Filed: Jul. 14, 2023

Related U.S. Application Data
(60) Provisional application No. 63/368,390, filed on Jul. 14, 2022.

(51) Int. Cl. B66F 9/06

(52) U.S. Cl. CPC B66F 9/063

(57) ABSTRACT

An advanced material handling vehicle is provided. Specifically, the advanced material handling vehicle can include one or more sensors coupled to a body of the material handling vehicle and electrically coupled to a processor. The processor executes instructions related to a perception system that monitors a location of the advanced material handling vehicle and controls one or more tasks and functions of the material handling vehicle based on sensor data.

### RELATED APPLICATIONS

This application claims priority to U.S. Provisional Patent Application No. 63/368,390, filed on Jul. 14, 2022, the entire disclosure of which is incorporated herein by reference.

### BACKGROUND

A conventional material handling vehicle, such as a forklift, has a multi-level mast provided on its body and a carriage having a load carrying apparatus, such as forks, wherein the load carrying apparatus is designed to be liftable along a mast. At the time of performing a load pickup work or load deposition work at a high place in a rack, a driver operates a load handling lever to protract or retract the multi-level mast by hydraulic driving to move the forks upward along the mast to position the load carrying apparatus to a pallet in the rack or a shelf surface.

The driver must manipulate the load handling lever while visually checking if the forks are positioned to holes in the pallet or a position above the shelf surface by looking up at a high place (e.g., 3 to 6 meters) from below. In some instances, it can be difficult to determine if the forks and a pallet or the like are positioned just by looking up at a high place, and even a skilled person needs time for this positioning.

For a sizeable warehouse, many skilled operators would be needed in order to operate the material handling vehicles, which can result in significant labor costs. However, automation for such material handling vehicles remain difficult for many reasons.

For example, within a warehouse, conventional position systems such as a global positioning system (GPS) are incapable of precise and accurate geographic location of a material handling vehicle for automation. Likewise, a warehouse often contains narrow spaces in between racks and at drop-off locations at or near a loading dock, and other environmental hazards that make automation difficult.

Within the environment of the warehouse, there are additional obstacles such as pallets, other material handling vehicles, and workers, all of which must be accounted for and navigated around to prevent bodily harm or property damage.

As such, there is a need for an advanced material handling vehicle that is capable of handling materials (such as pallets) while being able to navigate around a geographic location (such as a warehouse) and identify, map, and/or recall various objects disposed within the warehouse.

### SUMMARY

This disclosure generally relates to an advanced material handling vehicle. More specifically, the disclosure relates to an advanced material handling vehicle equipped with a perception and automation system. Some embodiments provide a perception system for monitoring a location and controlling one or more functions of a material handling vehicle as it travels around a warehouse environment.

Some embodiments provide a material handling vehicle including a mast moveably coupled to a body of the material handling vehicle, a motor coupled to the body, and a wheel coupled to the motor. The material handling vehicle further includes a perception system designed for real-time locating of the material handling vehicle. The perception system includes a hardware subsystem with one or more sensors coupled to the body of the material handling vehicle and electrically connected to a processor. The processor is configured to process sensor data collected from the hardware subsystem. The perception system also a task subsystem designed to perform one or more tasks and a focus manager subsystem designed to determine priority for the one or more tasks to be performed.

In some embodiments, the material handling vehicle further includes an item subsystem for aggregating object features from the sensor data into defined items. In some forms, the material handling vehicle further includes a multi-level localization system for identifying objects from the sensor data. In some embodiments, the multi-level localization system includes a first localization level provided in the form of an Oriented FAST and Rotated BRIEF (ORB) feature matching module (or similar feature matching system) for object detection within a warehouse environment. The multi-level localization system can further include a second localization or odometry level designed to analyze features identified within one or more image frames from a generated aggregate data set of the sensor data. In some forms, the one or more sensors of the material handling vehicle can be provided in the form of a camera or a laser scanner. In some forms, the perception system determines one or more of a speed, distance, or location of the material handling vehicle based on an analysis of the second odometry level. In some forms, the one or more tasks of the task subsystem includes a vision location tracking task for detecting a location of the material handling vehicle relative to one or more identified features extracted from the sensor data.

Some embodiments provide a material handling vehicle including a lifting device moveably coupled to a body of the material handling vehicle, an automation system for executing one or more automation tasks, and a perception system designed for real-time locating of the material handling vehicle. The perception system includes one or more sensors coupled to the body of the material handling vehicle and designed to collect sensor data. The perception system also includes a task subsystem designed to perform one or more tasks including a vision location tracking tasks with a multi-level localization for object detection and location monitoring.

In some embodiments, the lifting device is provided in the form of a vertical mast and the one or more sensors is provided in the form of a camera designed to collect one or more image frames. In some forms, the automation system executes the one or more automation tasks in response to the one or more tasks performed by the task subsystem. In some forms, the one or more automation tasks of the automation system includes a hazard avoidance task or a collision avoidance task. In some embodiments, the vision location tracking task is designed to monitor a location of the material handling vehicle relative to one or more features identified from the sensor data.

Some embodiments provide a method for real-time monitoring of a material handling vehicle using an advanced perception system. The method includes collecting sensor data from one or more sensors of a hardware subsystem of the material handling vehicle. The method also includes processing the sensor data collected from the hardware subsystem and identifying one or more tasks to be completed by a task subsystem based on the processed sensor data. The method further includes determining a priority for the one or more tasks using a focus manager subsystem and controlling the material handling vehicle to perform the one or more tasks based on the determined priority for the one or more tasks.

In some embodiments, the one or more sensors is provided in the form of a camera and the sensor data includes one or more image frames captured using the camera. In some forms, the step of processing the sensor data further includes the step of detecting one or more objects from the sensor data and identifying the one or more object. In some forms, determining the priority for the one or more tasks further includes providing rules to create a hierarchy of priorities based on the sensor data received from the task subsystem. In some embodiments, the method further includes capturing one or more image frames using a camera of the hardware subsystem, processing the one or more image frames, performing text recognition on the one or more image frames using edge detection, and creating a bounding box around one or more detected objects from the one or more image frames. The image processing can include the steps of receiving the one or more image frames, applying a gaussian blur, resizing the images, converting a color spectrum of the images, applying a color filter, and creating an image mask to the one or more image frames.

### BRIEF DESCRIPTION OF THE DRAWINGS

FIG. 1 illustrates a side view of an advanced material handling vehicle according to an exemplary embodiment;

FIG. 2 illustrates an isometric view of an advanced material handling vehicle according to another exemplary embodiment;

FIG. 3 illustrates an isometric view of a portion of an advanced material handling vehicle approaching a pallet;

FIG. 4 illustrates a partial top perspective view of a warehouse;

FIG. 5 illustrates a simplified block diagram of a perception system and associated logic for an advanced material handling vehicle;

FIG. 6A illustrates a block diagram of a focus manager subsystem with tasks that can be performed by an advanced material handling vehicle according to their priorities;

FIG. 6B illustrates a block diagram of custom applications for use in the perception system of FIG. 5; and

FIG. 7 illustrates a block diagram of an example of the OpenCV system for the task system process for the perception system of FIG. 5.

Before explaining the disclosed embodiments of the present invention in detail, it is to be understood that the invention is not limited in its application to the details of the particular arrangements shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While this invention is capable of embodiments in many different forms, there are shown in the drawings, and described in detail herein, specific embodiments with the understanding that the present disclosure is an exemplification of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention.

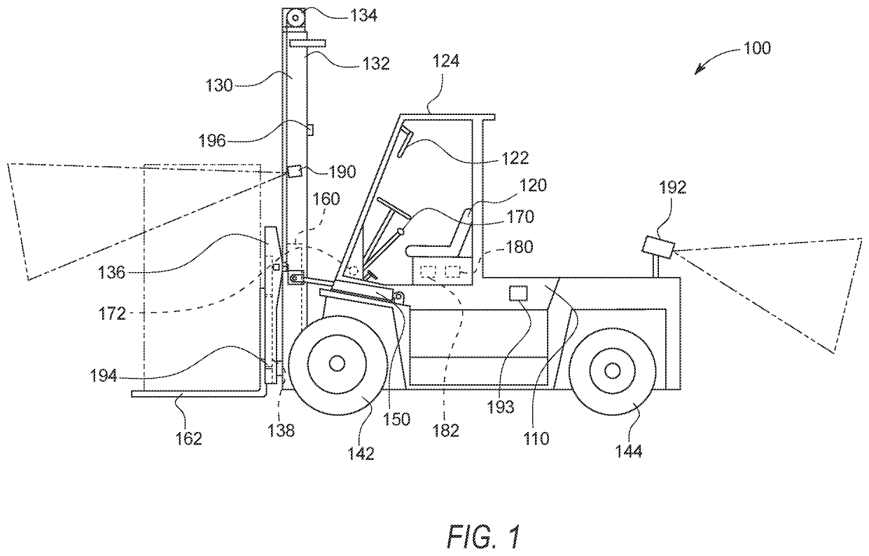

Referring to FIGS. 1-7, various embodiments of an advanced material handling vehicle and associated perception system are described herein.

FIG. 1 illustrates an advanced material handling vehicle according to an embodiment. Specifically, a counterbalance type forklift truck 100 is illustrated, although the systems and processes described herein can be applied to other types of material handling vehicles.

The forklift 100 can comprise a body 110 with a driver's seat 120 provided at a front portion of the body 110. A mast 130 can be provided in front of the driver's seat 120. The body 110 can further be connected to a set of wheels provided in the form of a pair of front wheels 142 and a pair of rear wheels 144, at a front portion and at a rear portion of the body 110, respectively. Depending on the embodiments, either the front wheels 142 can be used for steering the forklift 100 or the rear wheels 144 can be used for steering, or both set of wheels can be used for four-wheel steering. In some embodiments, the wheels can be provided in the form of tracks or other forms of movable support for the forklift 100. In some embodiments, the wheels can include encoders (not shown), which can collect and process data related to the distance traveled by the forklift 100 or other parameters related to the forklift operation.

The mast 130 can be supported on a front axle so that the mast 130 can be tiltable in a forward or a backward direction with respect to the body 110. The tilting of the mast 130 can be accomplished by using a tilt cylinder 150. The tilt cylinder 150 can retract or protract, thereby tilting the mast 130.

In an exemplary embodiment, the mast 130 can be a two-level slide mast that include an outer mast 132 and an inner mast 134. The outer mast 132 can be supported on the body 110 in a tiltable manner, and the inner mast 134 can be supported on the outer mast 132 in a liftable manner. The inner mast 134 can further support a lift basket 160 and forks 162. Moreover, the outer mast 132 can be provided with one or more lift cylinders to lift or lower the inner mast 134 with the lift basket 160 and the forks 162. It is to be understood that the forklift 100 can include other mast configurations, lifting devices, and load-carrying features.

A control lever 170 can be provided on the driver's seat 120 for controlling the forklift 100. For example, the control lever 170 can be used to shift the forklift 100 into forward or backward movements. The control lever 170 can be coupled to and in communication with a direction sensor 172, which can further be coupled to a processor 180 provided onboard the body 110 of the forklift 100. In an embodiment, the direction sensor 172 can be designed to detect whether the forklift is moving forward or moving backward vis-a-vis the position of the control lever 170. In other instances, the control lever 170 may be replaced with one or more buttons, user interfaces, touch screen, or other control mechanisms.

A forward sensor 190 can be provided in front of the forklift 100. The forward sensor 190 can be a data capture device like an individual sensor (e.g., camera), or a collection of sensors that can include, for example, one or more laser scanners, accelerometers, gyro sensors, proximity sensors, radars, lidars, optical sensors (such as infrared sensors), acoustic sensors, barometers, thermometers, and/or other suitable sensors. The forward sensor 190 can also be communicatively, electrically, and/or otherwise coupled to the processor 180.

The forward sensor 190 can be designed to detect conditions in front of the forklift 100, such as the presence of an obstacle. By way of example, the forward sensor 190, together with the processor 180, can sense various parameters corresponding to the surrounding environment and determine that the forklift 100 is approaching one or more of a pallet, an object, a person, or an environmental condition or hazard (such as a step, a stair, a spill, a drop-off, and the like). In some embodiments, the forward sensor 190 can be mounted at a location on the forklift 100 so that it can supplement a field of view of an operator, whose field of view may be obstructed when the forklift 100 is carrying a load.

The forklift 100 can further include a backward sensor 192. Similar to the forward sensor 190, the backward sensor 192 can be provided in the form of a data capture device such as an individual sensor, or a collection of sensors, including, but not limited to, one or more cameras, laser scanners, accelerometers, gyro sensors, proximity sensors, radars, lidars, optical sensors (such as infrared sensors), acoustic sensors, barometers, thermometers, and/or other suitable sensors. The backward sensor 192 can similarly be communicatively, electrically, and/or otherwise coupled to the processor 180.

The backward sensor 192 can likewise be designed to detect conditions and obstacles behind the forklift 100. By way of some examples, the backward sensor 192, together with the processor 180, can sense various parameters corresponding to the surrounding environment and determine that the forklift 100 is approaching a pallet, an object, a person, or some environmental condition or hazard (such as a step or a stair). In some embodiments, the backward sensor 192 can be mounted at a rear portion of the body 110.

The forklift 100 can further include one or more of a side sensor 193. Similar to the forward sensor 190 and the backward sensor 192, the side sensor 193 can be provided in the form of a data capture device such as an individual sensor or a collection of sensors, including, but not limited to, one or more cameras, laser scanners, accelerometers, gyro sensors, proximity sensors, radars, lidars, optical sensors (such as infrared sensors), acoustic sensors, barometers, thermometers, and/or other suitable sensors. The side sensor 193 can similarly be communicatively, electrically, or otherwise coupled to the processor 180.

The side sensor 193 can likewise be designed to detect conditions and obstacles beside the forklift 100. By way of some examples, the side sensor 193, together with the processor 180, can sense various parameters corresponding to the surrounding environment and determine that the forklift 100 is one or more of approaching a pallet, an object, a person, or some environmental condition or hazard (such as a step or a stair). In some embodiments, the side sensor 193 can be mounted on one or both of a side portion of the body 110. Some embodiments may utilize a plurality of side sensors 193 or mounting configurations to increase the viewing range and/or detection sensitivity of the side sensor 193. Some embodiments can provide sensor configurations and mounting locations to provide up to a 360° viewing range for the forklift 100 operator. Accordingly, by way of example, the forward sensor 190, backward sensor 192, and the side sensor 193 can all be designed to detect aisles, racks, and barcodes on objects as a forklift 100 travels down an aisle.

A back rest 136 coupled to the mast 130 can further be provided with a load sensor 194. Similar to the forward sensor 190, the load sensor 194 can be provided in the form of one or more strain gauge load cells, hydraulic load cells, pneumatic load cells, capacitive load cells, piezoelectric transducer, and the like, or combinations thereof. Further, the load sensor 194 can be provided in the form of an individual sensor or a collection of sensors, including, but not limited to, one or more cameras, laser scanners, accelerometers, gyro sensors, proximity sensors, radars, lidars, optical sensors (such as infrared sensors), acoustic sensors, barometers, thermometers, or other suitable sensors. The load sensor 194 can similarly be communicatively, electrically, or otherwise coupled to the processor 180. The back rest 136 can also include an aiding device 138 that can be used to physically adjust a position of the load sensor 194. The aiding device 138 can help properly position the load sensor 194 for optimal efficiency.

The load sensor 194 can be designed to detect conditions relating to the load. By way of some examples, the load sensor 194, together with the processor 180, can sense various parameters corresponding to a load positioned on the forks 162 and/or parameters corresponding to the surrounding environment to determine whether a load is properly loaded onto the forks 162, the balance of the load, and a distance of the load from the back rest 136. The load sensor 194, together with the processor 180, can further be designed to perform other functions such as identifying the type of load or determining a precise location of a pallet relative to the forklift 100.

In addition, the outer mast 132 can include a height sensor 196, which can be communicatively, electrically, and/or otherwise coupled to the processor 180. The height sensor 196, together with the processor 180, can be used to determine a height of the forks 162 and to ensure proper balancing of the forklift 100.

A display 122 can be provided near the driver's seat 120. In an embodiment, the display 122 can be provided on a bottom surface of a roof 124 above the driver's seat 120. However, the exact location of the display 122 can vary depending on the embodiments. The display 122 can be coupled to the processor 180. The display 122 can be designed to show various data or images gathered or collected by the sensors onboard the forklift 100, such as the forward sensor 190, backward sensor 192, the side sensor 193, the load sensor 194, and the height sensor 196. The display 122 can be provided in the form of a liquid crystal display (LCD), an organic light-emitting diode (OLED) display, or other device configured to display data and images. The display 122 can further include an interface module, which can include one or more light emitting diode (LED) indicators or other icons, display configurations, indicators, and the like. The display 122 can also include, or otherwise be operatively connected to, a computing device or computer display (not shown). The interface module may include one or more displays or widgets for displaying the output of the processing module and associated post-processing methods described herein. The display 122 can also accept user input such that the data and output information can be manipulated, edited, or otherwise modified during the processing methods. The display 122 can also include one or more control devices for controlling the forklift 100 and individual subassemblies thereof.

The forklift 100 can further include one or more additional processors 182 in addition to the primary processor 180. The additional processors 182 can be used to lighten the processing load of the primary processor 180. In an embodiment, the primary processor 180 can be used for perception related operations, while the additional processors 182 can be used for other operations such as load handling, navigation, balancing, or other suitable tasks. Depending on the embodiments, the additional processors 182 can be omitted and the primary processor 180 is designed to accomplish all the processing alone, or the processing can be distributed to remote severs for distributed computing.

It is to be appreciated that the forklift 100 can further include one or more additional sensors positioned at different locations on the forklift 100. Some of these additional sensors can include, for example, a weight sensor, a tilt angle sensor, balance sensors, and the like. These additional sensors can be positioned at appropriate locations on the forklift 100 depending on the circumstances, and be communicatively, electrically, or otherwise coupled to the processor 180.

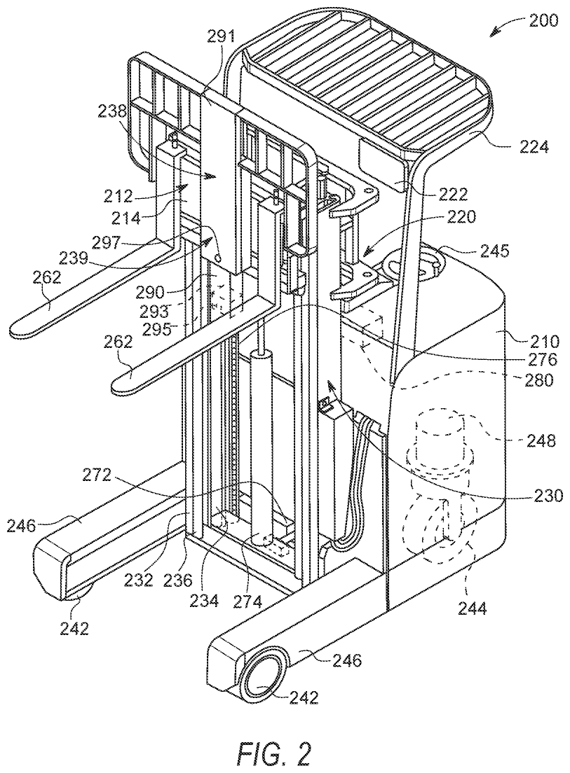

FIG. 2 illustrates an additional advanced material vehicle according to another exemplary embodiment. Here, a reach type forklift truck 200 is shown.

The forklift 200 can include forks 262 for carrying a load. The forklift 200 can include left and right front wheels 242 respectively attached to a distal end portion of a pair of left and right reach legs 246 extending frontward from a front portion of a body 210. The body 210 can further be coupled to wheel 244 located at a rearward portion of the body 210. The wheel 244 can be coupled to a motor 248. The wheel 244 can be used for driving and steering the forklift 100. The motor 248 can be powered by a battery provided on or in the body 210. In some embodiments, the forklift 200 may be powered by an internal combustion system provided on or in the body 210.

A driver can operate the forklift 200 by steering the wheel 244 by manipulating a steering wheel 245 while standing on a stand type driver's seat 220 provided at a rear portion of the body 210.

A multi-level mast 230 can be provided on the front of the body 210. The mast 230 can be moveable relative along the reach legs 246 by a reach cylinder 272. The mast 230 can include an outer mast 232, an inner mast 234, and a middle mast 236. A carriage 212 can be provided for load handling. Further, a central lift cylinder 274 and a pair of side lift cylinders 276, including a left lift cylinder and a right lift cylinder, can also be provided to lift the carriage 212.

The central lift cylinder 274 can be provided upright on a bottom plate of the inner mast 234, and the carriage 212 can be lifted up and down along the inner mast 234 by driving the center lift cylinder 274. The side lift cylinders 276 can be provided upright at a back of the outer mast 232 and can be driven with the carriage 212 placed at the topmost end of the inner mast 234, and the driving causes the three-level masts 232, 234, and 236 to protract or retract. The forks 262 can be lifted up to, for example, a height of about 20 feet.

The forklift 200 can further include an aiding device 238, which supports an operation of positioning the forks 262 as they are extended to various heights. The aiding device 238 can include a front sensor lifting device 239, which is installed at the front center portion of the carriage 212. The front sensor lifting device 239 can include a forward sensor 290, which is retained in a housing 291 attached to the front center portion of the carriage 212 in such a way as to appear from below. The carriage 212 can further include a side shifter 214 to move the housing 291 leftward or rightward together with the forks 262.

The forward sensor 290 can be provided in the form of a data capture device such as an individual sensor, including a camera 293 with an imaging section 295 (e.g., lens), or a collection of sensors, including, but not limited to one or more cameras, laser scanners, accelerometers, gyro sensors, proximity sensors, radars, lidars, optical sensors (such as infrared sensors), acoustic sensors, barometers, thermometers, other suitable sensors, and/or a combination thereof. The forward sensor 290 can also be coupled to a processor 280. The housing 291 can further include one or more cutouts or windows 297.

A display 222 (such as an LCD display or an OLED display) can be provided at a roof 224 or other suitable locations such that an operator in the driver's seat 220 can see the display 222.

It is to be appreciated that the forklift 200 can further include one or more additional sensors at different portions of the forklift 200. Some of these additional sensors can include, for example, a weight sensor, a tilt angle sensor, balance sensors, and the like. These additional sensors can be positioned at appropriate locations on the forklift 200 depending on the operational requirements, working conditions, environment, and other circumstances.

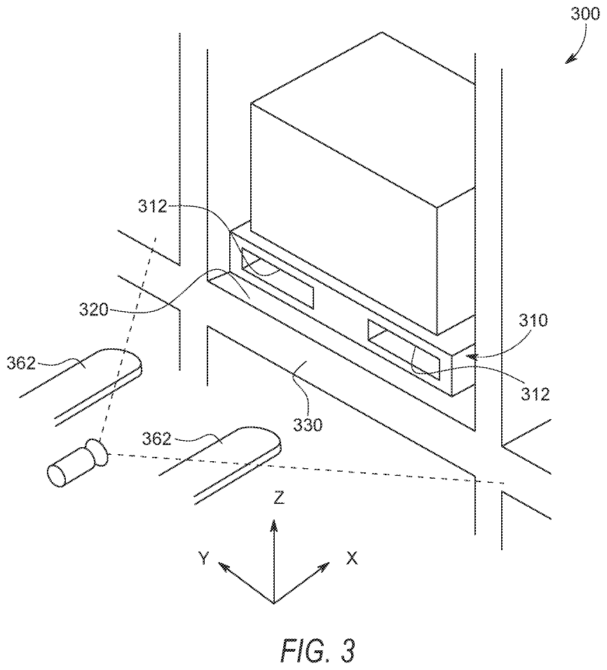

FIG. 3 illustrates a portion of an advanced material handling vehicle, such as an advanced material handling vehicle having any or all of the structures described above with respect to the forklift 100 or forklift 200, approaching a rack 300 with a pallet 310 thereon that can be loaded by forks 362 of the advanced material handling vehicle. The pallet 310 can include one or more insertion apertures 312 for engaging the forks 362. The rack 300 can include multiple shelf-surfaces 320 as well as frontal surfaces 330. The pallet 310 can be placed on (or removed from) one of the shelf-surfaces 320 by the advanced material handling vehicle. Moreover, one or more sensors (such as the forward sensor 190 or the load sensor 194 of FIG. 1) of the advanced material handling vehicle can be designed to detect the frontal surfaces 330 and/or the pallet 310 in order to determine parameters such as a distance between the material handling vehicle from the rack 300 or from the pallet 310, and/or identify the load thereon.

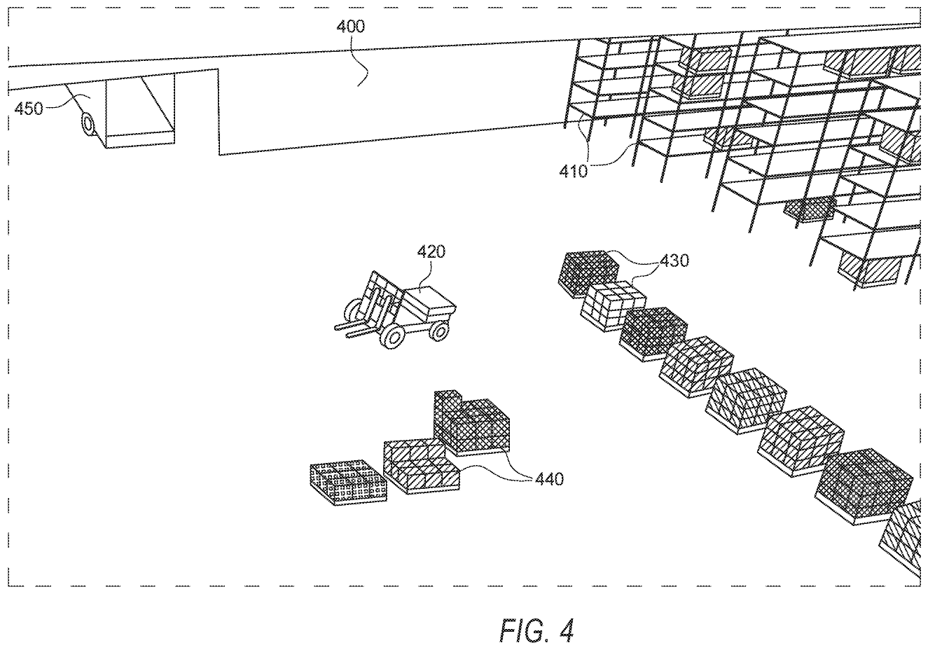

FIG. 4 illustrates a schematic view of a simplified warehouse 400. The warehouse 400 can include one or more rows of racks 410 that can be used to stack pallets thereon. Each of the racks 410 can have multiple levels of shelves, and each level of shelves can further be divided into individual partitions. Alternatively, the racks 410 can include open shelves with no additional partitions. The warehouse 400 can have one or more material handling vehicles 420 therein having any or all of the structures described above with respect to the forklift 100 or forklift 200. Various obstacles or hazards may be located throughout the warehouse 400. By way of example, the pallets 430 and 440 may be located throughout the warehouse 400. In an example, the pallets 430 can be provided in the form of stacked pallets awaiting transfer to a rack 410 or a truck 450. It can certainly be appreciated that the warehouse 400 can include other obstacles or hazards relative to the material handling vehicle 420 that the material handling vehicle 420 would need to avoid. Some examples of the obstacles include workers in the warehouse 400, additional material handling vehicles, furniture, fixtures, hallways, doorways, structural pillars or columns, walls, and many more. In addition, the warehouse 400 can include some hazards that can potentially damage the material handling vehicle 420 or its operator/driver. Some examples of the hazards can include steps or stairs, uneven warehouse floor, electrical wires, spills, elevated or improperly seated loading dock, and the like. The warehouse 400 can also include additional elements that would not obstruct proper navigation of the material handling vehicle 420, for example, light fixtures on the ceiling or on the wall.

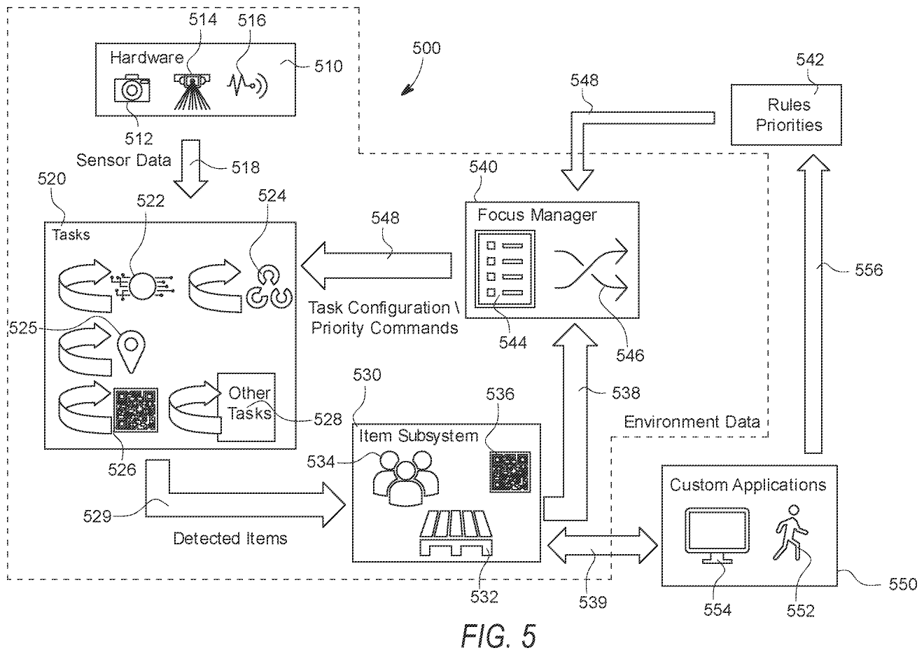

FIG. 5 illustrates a simplified block diagram of a perception system 500 and associated logic for an advanced material handling vehicle, such as the forklift 100 or forklift 200, according to an exemplary embodiment. A first component of the perception system 500 is a hardware subsystem 510. The hardware subsystem 510 can include various sensors provided on one or more advanced material handling vehicles, including the sensors described in connection with FIGS. 1 and 2. By way of example, some of the sensors can be provided in the form of data capture devices and can include a camera 512, a laser scanner 514, other sensors 516, or a combination thereof. In addition, some of the sensors for the hardware subsystem 510 may not be located on the advanced material handling vehicle. Instead, some sensors can be positioned throughout a warehouse or other facility or location, installed on a pallet, carried by a person, or installed on other types of vehicles or objects. Thus, it is to be appreciated that the hardware subsystem 510 can include sensors and hardware installed on a variety of locations not limited to just the advanced material handling vehicle, such as the forklift 100 or forklift 200. Therefrom, the hardware subsystem 510 can transmit sensor data 518 obtained by the hardware subsystem 510, or other data elements, to a task subsystem 520.

The task subsystem 520 executes the logic needed to perform a specific function of the perception system 500, such as by way of a software application, and can further comprise of one or more individual tasks. By way of example, the task subsystem 520 can include a TensorRT task 522, an OpenCV task 524, a vision location tracking task 525, an ARTag task 526, and other tasks 528. In some embodiments, the task subsystem 520 can include (or interface with) one or more advanced training modules and libraries, such as PyTorch, or ONNX. In some embodiments, the advanced training modules can include machine learning models, deep learning models, neural networks, or other artificial intelligence training models. The advanced training module can be incorporated into one or more of the tasks, or otherwise trained to execute a task or a portion thereof. These deep learning models can be external to the perception system and can be integrated with the task subsystem 520 in a way that allows the task subsystem 520 to pull tasks from different models as part of broad deployment strategy utilizing the perception system 500 and subsystems therein.

The TensorRT task 522 can relate to a deep learning capability of the perception system 500. Specifically, using a TensorRT engine, the sensor data 518 collected by the hardware subsystem 510 can be used to train the TensorRT engine. Here, TensorRT is a high-performance deep learning interface developed by NVIDIA. However, it is to be appreciated that TensorRT is but one exemplary embodiment of a deep learning interface that can be used, as other suitable deep learning engines can also be used for TensorRT task 522.

The OpenCV task 524 can relate to real-time computer vision capability of the perception system 500. Specifically, using OpenCV, the task subsystem 520 can interpret the sensor data 518 collected by the hardware subsystem 510 and discern the items or objects being detected by the hardware subsystem 510. By way of example, the OpenCV task 524 can use an image, or multiple images, captured by one or more cameras 512 of the hardware subsystem 510 to determine whether an object or an item is present. To make this determination, one embodiment of the OpenCV task 524 can apply a digital imaging filter, or a plurality of filters, to an image frame. The filtered image frame produces a data array associated with data for one or more items in the image. For example, the one or more images can be sent to multiple task subsystems 520 to process the image data at different priorities and frequencies. After the multiple task subsystems 520 process the image data the processed image and corresponding data arrays are then communicated to an item subsystem 530, described in more detail below.

The vision location tracking task 525 can include a multi-level localization system. The multi-level localization system can be used in connection with both the perception system 500 and an automation system 554 (described in detail below) for one or more of evaluating parameters of a surrounding environment (e.g., features of a warehouse), determining a location of one or more advanced material handling vehicles, and/or tracking the movement of one or more of the advanced material handling vehicles. In some embodiments, a determination of the vision location tracking task 525 can be an input to the automation system 554 and can trigger an action, notification, or similar response based on the processes of the vision location tracking task 525.

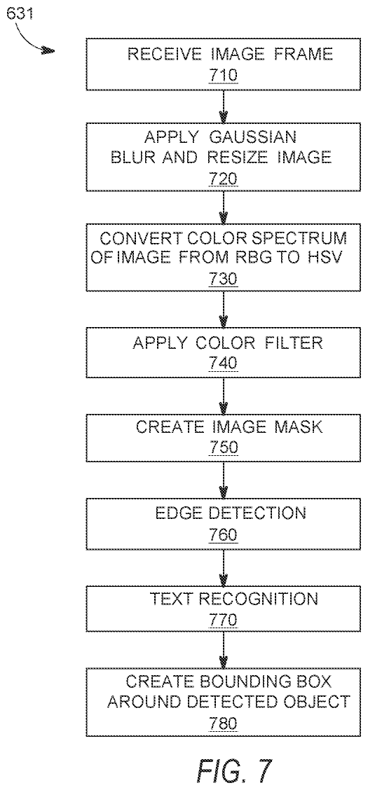

The multi-level localization system of the vision location tracking task 525 can include a first localization level, a second odometry level, and a third coarse localization level. Some embodiments can include additional odometry or localization levels or modules associated with the vision location tracking task 525. In some embodiments, the vision location tracking tasks 525 can include one or more of the object detection and image processing techniques described in connection with FIG. 7.

The first localization level can be provided in the form of an Oriented FAST and Rotated BRIEF (ORB) feature matching module for object detection within a warehouse or other industrial environment. In some embodiments, the ORB feature matching module can be implemented using brute-force matching techniques with ORB descriptors and/or manual recognition processes. Some embodiments utilize OpenCV to implement the ORB feature matching module, although other computer vision and machine learning technologies can also be used in connection with the first localization level.

The second odometry level includes an analysis of relative features identified within one or more image frames from a generated aggregate data set. The aggregated data set can be analyzed to identify individual features or portions thereof based on a comparison of aspects of the features as they appear in multiple image frames. For example, images can be captured by a data capture device, like a camera or other sensor of the perception system 500, as the forklift 100 moves about a warehouse environment. An image frame of a particular pallet in the warehouse may have different visual representations in different frames, depending on the angle of the data capture device relative to the pallet as the forklift moves. The second odometry level can use image processing, including one or more filters and contrast adjustments to identify features using the ORB feature matching of the first localization level and monitoring the orbs through one or more image frames to measure an optical flow and determine a speed, distance, location, and other parameters related to the movement of the forklift 100 through the warehouse environment.

The third localization level can be provided in the form of a high-level localization process based on landmark features. In some embodiments, the third localization level can include a pre-defined set of data values, including but not limited to tags, signs, pillars, locations, a warehouse map, zones, etc. In some embodiments, the perception system 500 can receive an image frame from a data capture device, process the image using one or more image processing techniques, identify one or more identifying landmark features (e.g., aisle identification number, exit sign, stop sign, etc.), and compare the identifying landmark feature to known landmark features of the pre-defined set of data values to determine a location associated with the landmark feature and/or the forklift 100 relative to the identified landmark feature.

The vision location tracking task 525 can further include one or more advanced training modules trained for image detection, object recognition, location classification, and other specific tasks or processes. In some embodiments, one advanced training module can be iteratively trained or configured to perform a combination of tasks or processes in connection with the vision location tracking task 525. In some embodiments, the vision location tracking task 525 can collect aggregate data sets of individual data elements (e.g., orb dots extracted from an image associated with one or more detected features or objects of the warehouse environment). The system can use the aggregate data sets to create a library of known, identified, detected, and classified objects within the warehouse space. In at least this way, the system can allocate fewer resources to feature identification as new images are collected and features are compared to known features already identified in connection with a particular location. The vision location tracking task 525 can further analyze the angle of the identified feature to the known location to determine the precise location of the data capture device when the image was captured and can track a speed of a forklift based on timestamps of the image frames and the iterative changes in the angles of the identified features.

In some embodiments, the vision location tracking task 525 can further include a degradation algorithm to generate a confidence level associated with one or more landmark features, in particular, with high contrast features such as the corners or edges of objects, warehouse racks, or other features of the warehouse. Corners or edge features in a warehouse, such as at the end of an aisle or wall typically degrade much higher than general warehouse space. The system can filter collected data sets and determine appropriate tolerance ranges based on an iteratively trained advanced training module to identify landmark features around an identified or suspected corner location.

Further, in some embodiments, the advanced training module can be trained based on rules and patterns for landmarks in a specific location. For example, if a particular corner or edge of the warehouse, warehouse rack, or object is often used for loading/unloading, the degradation algorithm can be trained to determine patterns in the time of day associated with loading/unloading and place a high priority on identifying people and pallets and other movable or moving objects in contrast to a lower priority for a landmark feature, like the identification sign above the loading dock door. The system can determine that more frequent scanning and processing is required for the portion or portions of the corners or edges associated with loading/unloading, for example, that are likely to have a person walking in the area, compared to the scanning and processing updates needed for a location known in connection with a warehouse feature or object that is not high contrast. In at least this way, the system can prioritize filtering techniques or other data processing methods to implement real-time updates in connection with a landmark feature identification synchronization process.

In some embodiments, the vision location tracking task 525 can include a communication interface between multiple aspects of the warehouse environment, including other advanced material handling machines, a central controller, or similar. In at least this way, the system can leverage information collected and processed by other vehicles in order to inform intelligent decision making by the automation system 554 and update the perception system 500 according to the overall vision location tracking tasks 525 performed among the vehicle fleet. As the system identifies features and objects throughout the warehouse environment, the identification can include classification using labels, tags, fiducial markers, or other types of digital marking.

For example, the ARTag task 526 can relate to fiducial marker capability of the perception system 500. Specifically, the ARTag task 526 can create fictional markers, or an augmented reality (AR) tag 536 relative to real-life objects in augmented realities. Thus, the ARTag task 526 can include virtually marking one or more detected items 529 or objects that have been detected using the sensor data 518. For example, an AR tag 536 can be virtually associated with on an object in the warehouse environment. The AR tag 536 is used by the perception system 500 to detect and recognize a pattern for the object. The perception system 500 can superimpose a virtual object corresponding to the AR tag 536 when the perception system 500 detects an object matching, or nearly matching the stored pattern associated with the AR tag 536. For example, when an AR tag 536 is placed on a pallet 532 in the warehouse, the perception system 500 can use the AR tag 536 to detect and recognize a pattern of the pallet 532 and store the pattern so that when the perception system 500 detects another pallet using the sensor data 518, the perception system 500 recognizes the detected pallet and associates it with the AR tag 536 for a pallet. The ARTag task 526 can be used to identify other objects throughout the warehouse and can be designed to facilitate detection of objects that may exhibit a slightly modified position or pattern than the originally detected object.

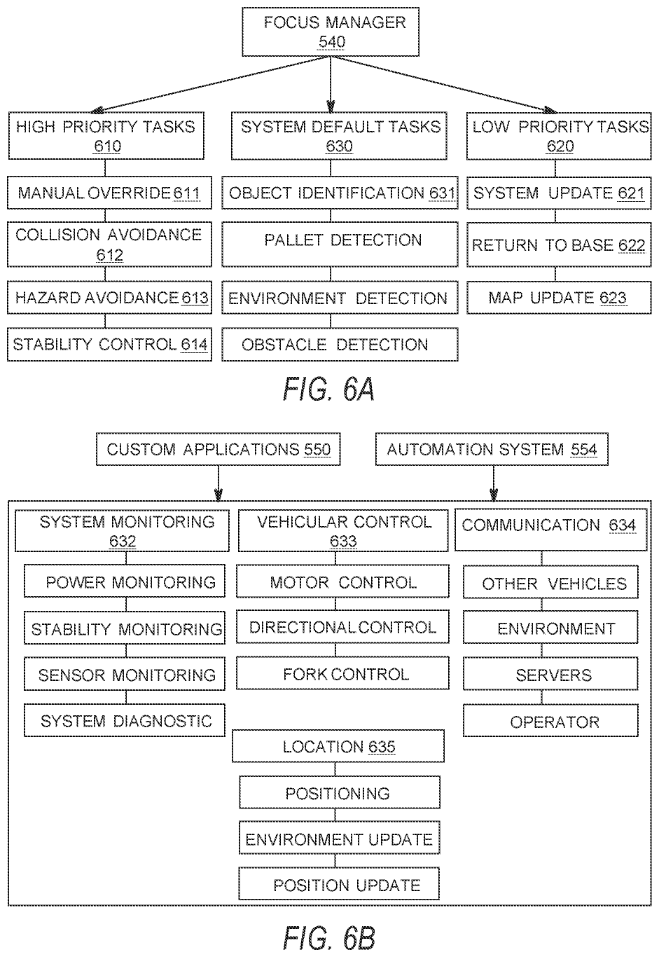

The other tasks 528 can include tasks related to other functionalities of the advanced material handling vehicle. Some of the examples of the other tasks 528 are shown in FIG. 6A, which will be described in more detail herein.

The task subsystem 520 using the various tasks therein can decipher and detect items and objects based on the sensor data 518 collected by the hardware subsystem 510. As discussed above, data associated with detected items 529 can be fed into the item subsystem 530 along with the data from the one or more cameras 512 indicating the camera location. The item subsystem 530 can use the data associated with the detected items 529 that is generated by the task subsystem 520, including data from multiple images and multiple camera locations, to combine or aggregate items or objects into discrete items that can be shared with other clients (such as a focus manager subsystem 540 or users or operators). In particular, the item subsystem 530 can take positional information and other data detected or inferred from the task subsystem 520 and use statistical probability to estimate whether multiple objects are the same. The item subsystem 530 can also look at the same data set detected in multiple locations, for instance a moving object in multiple image frames detected by the one or more cameras 512. The item subsystem 530 further contains a memory retention component that can process the data from one or more image frames and recognize based on the location of the objects and the location of the one or more cameras, that an object was previously detected and is no longer in the same location. This can be useful if the advanced material handling vehicle is moving, and the detected non-stationary objects, like humans 534 or other utility vehicles, are also moving or have moved.

Depending on the embodiments, any object can be an item. Some of the items or objects can include a pallet 532, other humans 534, or AR tags 536. However, an item can also include an absence of an object. For example, a pallet is a physical object, and therefore can be an item recognizable by the perception system 500. Likewise, a row of five pallets is also each individually a physical object and can each individually be an item within the perception system 500 (i.e., five pallets). However, a row of five pallets can itself be an item (i.e., a row of five pallets instead of five individual pallet). By way of example, a row of pallets can include four pallets and an empty space sizeable enough for another pallet. Here, the empty space may not have a physical object thereon, but the empty space can be treated as an item by the perception system 500. Using a practical example, the perception system 500 can detect that there is a space large enough for one additional pallet, and therefore command the advanced material handling vehicle to move a pallet to the space. Thus, in this example, the space can be an item, and the pallet can be an identifiable item.

In certain situations, an item need not be a recognizable object by the perception system 500. Although the perception system 500 can be trained to detect common objects and items such as the pallet 532, human 534, or AR tags 536, a warehouse can also include many additional objects not commonly found in a warehouse environment. For example, in an embodiment, the perception system 500 may not be able to detect an animal such as a cat given that a cat is not commonly found in a warehouse, and thus the perception system 500 is not properly trained or configured for such. Nonetheless, the perception system 500 can still categorize such unknown objects (i.e., the cat) as an item within the item subsystem 530. In this case, the item subsystem 530 can assign an unknown object label to such an item, instead of being able to declare that the detected object is a cat.

The item subsystem 530 can use the detected items 529 from the task subsystem 520 to construct environment data 538 to be fed to the focus manager subsystem 540, the function of which is described in further detail below. The environment data 538 can include information about the environment around the advanced material handling vehicle. For example, the item subsystem 530 can notify the focus manager subsystem 540 that a pedestrian is within a certain location (e.g., ten feet) in front of the advanced material handling vehicle. In this example, the environment data 538 can include an item being a human 534, and the item is determined to be ten feet relative to the advanced material handling vehicle. The environment data 538 can also include direction of the item or the relative vector of the item. For example, the environment data 538 can include whether the detected item is ten feet in front of the advanced material handling vehicle, or whether the item is ten feet at 330 degrees of the advanced material handling vehicle. In this exemplary embodiment, the “front” can be at 0 degrees (which coincides with 360 degrees), and the “back” can be at 180 degrees, thus a location of an item can be plotted relative to the advanced material handling vehicle. In this example, an object located at 330 degrees can mean the item is front-left of the advanced material handling vehicle.

Object detection can also be performed by custom applications 550 external to the perception system 500. The custom applications 550 can include, for example, pedestrian detection 552 and the automation system 554, which can interface with, and/or integrate with the perception system 500 and the item subsystem 530. For example, while the automation system 554 could be an integrated feature of the perception system 500, the automation system 554 can also be configured as shown in FIG. 5 as an external custom application 550 that communicates with the perception system 500 via an interface 539. In this embodiment, systems external to the perception system 500 are those shown outside the dashed line of FIG. 5. In this embodiment, the automation system 554 utilizes the features of the perception system 500, including extracting information from the item subsystem 530 via the interface 539. Additionally, the custom applications 550 can each have a different set of rules or priorities 542. These rules 542 can be consolidated by a rule consolidation system 544 that can be used with rule configuration 546 to prioritize different rules based on the different applications and the status of the perception system 500. As shown in FIG. 5, the rule consolidation system 544 and rule configuration 546 can be integrated into the focus manager subsystem 540 and provided the rules or priorities 542. In other embodiments, the rule consolidation system 544 and rule configuration 546 can be external to the focus manager 540 and communicate priority commands 548, including the priorities 542, with the perception system 500.

In some embodiments, the focus manager subsystem 540 can use utilize the environment data 538 to create a hierarchy for determining priorities for tasks to be performed, such as the tasks described above with respect to the task subsystem 520, or commands to be issued, such as commands that control the operation of the advanced material handling vehicle. In this way, the focus manager subsystem 540 maximizes efficiency and minimizes processing power consumption. The focus manager subsystem 540 can include one or more rules or priorities 542 that acts as a set of policies to create the hierarchy of priorities based on the data and information received from the item subsystem 530 and/or the task subsystem 520. This information is used by the focus manager subsystem 540, which modifies a parameter of the task subsystem 520 and/or modifies control commands for the advanced material handling vehicle, based on the data received from the item subsystem 530 and the specific task to be performed. Accordingly, the modified task configuration(s) or priority command(s) 548 can be fed back to the task subsystem 520 to perform the appropriate task according to specific rules and priorities.

Referring to FIG. 6A, the focus manager subsystem 540, and some other tasks 528 within the task subsystem 520, are shown in more detail. In some forms, the other tasks 528 can include providing commands to perform vehicle controls, and in some forms, although various tasks are illustrated in FIG. 6B with respect to the custom applications 550 such as the automation system 554, all the tasks shown and described with respect to the custom applications 550 and/or the automation system 554 in FIG. 6B can be performed by, or included in, the task subsystem 520 of the perception system. In an exemplary embodiment, tasks can be categorized into three categories based on a priority of the underlying task. By way of example, tasks can be categorized as high priority tasks 610, low priority tasks 620, and system default tasks 630. Certainly, the categories can take on different labels such as “level 1 tasks”, “level 2 tasks”, and “level 3 tasks”, or other naming conventions. Likewise, depending on the embodiment, more or less than three categories of tasks can be provided.

High priority tasks 610 can include tasks that are critical for the safety of an operator of an advanced material handling vehicle. Some of the examples for high priority tasks 610 can include manual override 611, collision avoidance 612, hazard avoidance 613, and stability control 614. As can be appreciated, these types of high priority tasks 610 can directly or indirectly impact the safety of a human 534, and thus can be given the utmost priority.

In some embodiments, tasks can be executed and/or performed by external systems and/or the custom applications 550 (FIG. 5). For example, in one embodiment, the automation system 554 can execute tasks such as the collision avoidance task 612, hazard avoidance 613, and stability control 614. In this embodiment, the customs applications 550 are designed monitor the system using the system monitoring task 632 and communicate with an integrated vehicle controller (not shown) that would execute behaviors of the collision avoidance task 612 and the stability control 614, for example. As described above, it should be noted that all of the tasks shown and described with respect to the custom applications 550 can also be performed by the task subsystem 520 additionally, or alternatively, to the custom applications 550.

For example, when the operator initiates the manual override task 611, such a command should be given priority above all other tasks currently being performed by the perception system 500.

Likewise, when the advanced material vehicle is about to collide with an object or other human, the collision avoidance task 612 takes precedent before all other tasks in order to avoid a collision, which can cause bodily harm or property damages. Similarly, when the advanced material handling vehicle is traveling, pedestrian detection, which can be a subtask of the collision avoidance task 612, is prioritized above other tasks.

The hazard avoidance task 613 is another example of when the advanced material handling vehicle is faced with an environmental hazard (e.g., a drop-off or a stair). The focus manager subsystem 540 can prioritize avoiding the environmental hazard, thereby avoiding potential damage to the advanced material handling vehicle or to the operator.

The stability control task 614 is another example that can avoid potential harms. By way of example, the perception system 500, based on the sensor data 518, can determine that the advanced material handling vehicle is about to tip over if a fork is raised any further or that moving a load (such as a pallet) would cause the advanced material handling vehicle tip over, and the focus manager subsystem 540 can engage the stability control task 614, which provides commands to the advanced material handling vehicle or an operational parameter thereof (e.g., preventing the forks from being raise further) in order to maintain the stability of the advanced material handling vehicle, such as lifting or lowering the forks.

In another example, if the advanced material handling vehicle is performing pallet detection, which can be one of the system default tasks 630, pocket detection will be a lower priority until a pallet has been detected. When the perception system 500 detects a pallet and begins to assist in positioning the forks for pallet pick up, the pocket detection will be a higher priority than the pallet detection.

Similar to different categories of tasks, the high priority tasks 610 can also include one or more priorities of its tasks depending on the embodiment. For example, tasks can be prioritized such that the manual override task 611 takes precedent before the collision avoidance 612, which takes precedent before the hazard avoidance task 613, which takes precedent over the stability control task 614. Put differently, in such an example, when the focus manager subsystem 540 is deciding which task the perception system 500 should execute first, and there is more than one task to execute, the focus manager subsystem 540 first determines whether any, or multiple, high priority tasks 610 needs to be performed. If more than one high priority task 610 need to be performed, the focus manager subsystem 540 can select the task with the highest priority to perform first. For example, pedestrian detection is a high priority task 610 when the advanced material handling vehicle is in motion, but if the operator has the advanced material handling vehicle in reverse, pedestrian detection based on the rear camera of the vehicle can be prioritized higher than pedestrian detection in the forward camera of the vehicle. In which case, if the manual override task 611 is engaged by the operator, the focus manager subsystem 540 can disable some or all of the other tasks, thereby permitting the operator full control of the advanced material handling vehicle.

On the other end of the spectrum are the low priority tasks 620. In an exemplary embodiment, the low priority tasks 620 can include tasks of lesser importance, and therefore can wait until spare processing power is available for handling such tasks. The low priority tasks 620 can include tasks such as a system update 621, a return to base operation 622, or map update 623. In general, low priority tasks 620 can include tasks that do not impact a functionality of the advanced material vehicle in real time. For example, text detection and recognition would be considered a low priority task 620 while the advanced material handling vehicle is traveling, because pedestrian detection, collision avoidance task 612, and hazard avoidance task 613 would be a higher priority.

The system update task 621 can be a task that updates some or all software or firmware of the advanced material handling vehicle. For example, if a new software update is available for the advanced material handling vehicle, the perception system 500 can be notified through a communication interface onboard the advanced material handling vehicle. The focus manager subsystem 540 can then queue the system update task 621 to be performed under certain circumstances when the advanced material handling vehicle is not in operation. One of such circumstances can be when the advanced material handling vehicle is being charged at its charging base, or when the advanced material handling vehicle has been idle longer than a set period of time. Of course, other parameters can also be used before the focus manager subsystem 540 engages the low priority tasks 620.

The return to base task 622 can be another task with a lower priority. During normal operation, the advanced material handling vehicle would have no need to return to its charging base throughout a day. Thus, the focus manager subsystem 540 can initiate the return to base task 622 based on some predetermined conditions, such as when the advanced material handling vehicle has been idled for more than a period of time. However, under some circumstances, the return to base task 622 may need to be prioritized as system default task 630, which are higher priority than the low priority tasks 620. For example, if the advanced material handling vehicle is electric powered, and the battery onboard is about to be depleted, the focus manager subsystem 540 can promote the return to base task 622 to be a system default task 630 under such specific circumstances, so that the advanced material handling vehicle can return to its base to recharge its battery. Likewise, it is also possible that an operator may decide to recall the advanced material handling vehicle to its base for many other reasons. In such a situation, the focus manager subsystem 540 can treat the return to base task 622 as a high priority task 610 given that the operator requested the return of such advanced material handling vehicle. Any, or all, of the task priorities can be modified by operator actions, such as the operator specifically requesting a certain task, and any, or all, of the task priorities can be locked out or unchangeable with respect to any operator action. For example, pedestrian detection can always be categorized as the highest priority, and be unchangeable by any operator action, while system updates 621, can be increased in priority if a particular system update is desirable.

The map update task 623 can be another example of a low priority task 620. The advanced material handling vehicle can include a navigation system in order to navigate around a warehouse or other environments that the advanced material handling vehicle is located in. The map update task 623 can ensure that a map of the navigation system stays up to date. However, given that the map is unlikely to change frequently (for example, a layout of a warehouse is unlikely to change overnight), the map update task 623 can be one of lower priorities.

The system default tasks 630 can include tasks that ensure the advanced material handling vehicle is operational. Some of the examples can include object identification task 631, system monitoring task 632, vehicular control task 633, communication task 634, and location task 635. Each task can further be broken down into subtasks or processes.

Additionally, in one embodiment, as shown in FIG. 6B, external custom applications 550, like the automation system 554, can execute tasks like the system monitoring task 632, vehicular control task 633, communication task 634 and the location task 635. As mentioned above, any, or all of the tasks listed in FIG. 6B can be prioritized by, or executed by, commands from the focus manager 540 as well.

The object identification task 631 can utilize information obtained from the OpenCV task 524 to identify items or objects near the advanced material handling vehicle. For example, the object identification task 631 can include a subtask to detect a pallet, to detect other environment hazards, or to detect obstacles.

FIG. 7 provides an example of the object identification task 631 using the OpenCV task 524 by processing an image frame, or a plurality of image frames, in order to detect object(s) located within the image frame. At a high level, the OpenCV task 524 uses the color information obtained from an object detected by one or more cameras 512 (or sensors) and uses a mask, through digital image processing techniques, to detect the specific object within the image frame. More specifically, the steps of the OpenCV task 524 within the object identification task 631 first includes receiving an image frame 710 from one or more cameras 512. Second, a Gaussian blur 720 is applied to the image frame 710 and the image is resized to improve processing. The Gaussian blur 720 and resize step helps reduce noise within the image frame, improving the edge detection 760 later on. Next, the color of the image frame is converted from the red, green, and blue (RGB) values into its component planes: hue, saturation, and value (HSV) in a RGB to HSV conversion process 730. Next, a color filter is applied in step 740 to the HSV color model image to isolate the hue and saturation for the specific RGB threshold values for the specific object to be detected in the image frame. Using the color filter, and image mask is created in step 750, wherein the image mask isolates the identified pixel data associated with the specific hue and saturation of the object. Next, the resulting image is processed with an edge detection filter in step 760 to determine the contours of the object on the image mask created in step 750. The largest identified contour represents the boundary of the object dimension and text recognition can be performed in step 770 within the boundary of the object dimension. Finally, a boundary box is created in step 780 based on the detected dimension of the object. The boundary box can be used to determine the relative position of the object to other objects detected and identified in the image frame or with other objects in other image frames as identified and organized by the item subsystem 530.

An example of the object identification 631 can be demonstrated by a stop sign captured in an image frame. First, the image frame is processed with a Gaussian blur in step 720 and the image is resized. Then, the color spectrum of the image is converted from RBG to the HSV color model in step 730. A color filter is then applied to the image in step 740 to isolate the range of red hue with the required saturation associated with the stop sign object. An image mask is created from the color filter in step 750, isolating the pixel data that matches the identified threshold red hue and saturation levels. In step 760, the perception system 550 searches for the edges of an octagon pattern since an octagon is associated with the stop sign object. Additionally, the outer boundary of the octagon will be used as the object dimension for the stop sign. In step 770, text recognition is performed within the detected octagon image, looking for the text “STOP.” Finally, using the object dimension detected in the edge detection step 760, a boundary box is created around the detected stop sign in step 780 and the boundary box is used to determine the relative position of the stop sign to other objects, including racks, aisles, advanced material handling vehicles, and other objects.

Returning to FIG. 6, the system monitoring task 632 can include subtasks such as power monitoring, stability monitoring, sensor monitoring, system diagnostics, and the like. For example, when the system monitoring task 632 is running the subtask for power monitoring and detects that the advanced material handling vehicle is low on battery, the system monitoring task 632 can notify the focus manager subsystem 540 in order for the focus manager subsystem 540 to initiate the return to base task 622.

The vehicular control task 633 can include subtasks such as motor control, directional control (such as steering, forward, and reverse), and fork control, thus enabling the advanced material handling vehicle to operate autonomously. In a simplified example, the vehicular control task 633 can control the advanced material handling vehicle to navigate around the warehouse until the object identification task 631 identifies a pallet. Therefrom, the vehicular control task 633 can navigate the advanced material handling vehicle to approach the pallet through motor control and directional control. Thereafter, the vehicular control task 633 can engage fork control to thereby lift up the pallet before navigating the advanced material handling vehicle to its next destination (such as a rack for the pallet).

In another example, the object identification task 631 can identify that a person in close proximity in front of the advanced material handling vehicle and notifies the perception system 500. Therefrom, the focus manager subsystem 540 can initiate the collision avoidance task 612. In order to avoid an imminent collision, the collision avoidance task 612 can determine that the motor needs to be shut off immediately to stop the advanced material handling vehicle. Alternately, the collision avoidance task 612 can also determine that the advanced material handling vehicle must change velocity to pursue the safest behavior. The collision avoidance task 612 can report its determination back to the perception system 500. Thereafter, the focus manager subsystem 540 can either direct the vehicular control task 633 to stop the advanced material handling vehicle or to change its direction. Of course, the focus manager subsystem 540 can engage additional tasks such as hazard avoidance task 613 and/or stability control task 614 to determine whether stopping the advanced material handling vehicle or turning its direction would result in running into an environmental hazard or would cause the advanced material handling vehicle to flip over. If either one is positive, the focus manager subsystem 540 may then direct the vehicular control task 633 to maneuver the advanced material handling vehicle in a manner that both avoid a collision with the person and also avoid running into an environmental hazard or from tipping over.

The communication task 634 can include subtasks that enable the advanced material handling vehicle to communicate with other vehicles, with the environment, with servers, or with remote or onboard operators. For example, the communication task 634 can communicate with other vehicles to determine a right of way or relative positions of other vehicles. Similarly, the communication task 634 can communicate with an environment. In an example, a warehouse can have numerous beacons spread throughout the warehouse to enable the advanced material handling vehicle to position itself or to mark locations of certain objects such as a rack. The communication task 634 can enable the advanced material handling vehicle to communicate with these environmental beacons.

The communication task 634 can further include subtasks that enable the advanced material handling vehicle to communicate with one or more servers. These servers can be located onsite at a warehouse or located remotely offsite. Communication with the servers can enable the advanced material handling vehicle to perform additional functionalities that the advanced material handling vehicle may otherwise lack processing power to perform. Moreover, the communication task 634 can also include a subtask for communication with an operator. In some embodiments, the advanced material handling vehicle can be fully autonomous with no operator onboard. The operator communication subtask can allow the operator to remotely interact with the advanced material handling vehicle when necessary.

The location task 635 can include subtask relevant to navigating the advanced material handling vehicle. By way of example, the location task 635 can include a positioning subtask, where the advanced material handling vehicle gathers environmental data to determine its location within a geographic location. The positioning subtask can be performed through triangulation with other objects (such as beacons installed racks or other vehicles within a warehouse), through sensors onboard (such as using a combination of sensors to create a virtual map of the warehouse), through a satellite-based radionavigation system (such as GPS), or other methods or combination of methods that are suitable for positioning the advanced material handling vehicle.

The location task 635 can also include an environment update subtask, where when the advanced material handling vehicle detects that, for example, a rack has been moved or a door has been closed, it can notify the perception system 500 to update a virtual map used for navigation. Likewise, the location task 635 can also include a position update subtask that updates a real-time position of the advanced material handling vehicle without a geographic location.

Using the perception system 500 of FIG. 5, the advanced material handling vehicle can also be capable of performing real-time locating solution (RTLS). Specially, using the sensor data 518 collected by the hardware subsystem 510, the advanced material handling vehicle can aggregate known elements to determine a location of the advanced material handling vehicle within a geographic location such as a warehouse.

By way of example, using data collected by cameras 512, the perception system 500 can determine that the advanced material handling is near a specific object, and is, therefore, at a location in the warehouse. Specifically, the warehouse may include multiple rows of racks. These racks may have signs thereon such as “A1”, “A2”, “A3”, “B1”, “B2” or the like. When the camera 512 captures an image where the perception system 500 is able to extract “A1” from the image for example, it can result in the perception system 500 determining that the advanced material handling vehicle is near the “A1” rack. Likewise, when in the image, the “A1” text is extracted from a leftward portion of the image taken by a forward camera, the perception system 500 can interpret that the A1 rack is in front and to the left of the advanced material handling vehicle.

Other objects can also be used for a natural feature based visual RTLS. For example, the perception system 500 can also be trained to recognize additional identifiable landmarks using one or more cameras 512 (or sensors). Examples of identifiable landmarks may include, for example: stop signs, columns, pillars, dock doors, racks, aisles, lanes, or other objects that may be unique to the warehouse environment. The visual RTLS system can also operate off a pre-populated map with identified landmarks, in place of, or addition to, a map created with the machine learning techniques that may be used to train the perception system 500. The visual RTLS system can then compare the identified landmark detected by the one or more cameras 512 (or sensors) and compare the identified landmark to the map, localizing the system to determine the location of the advanced material handling vehicle. Put simply, by knowing where these landmarks are located within the warehouse, the perception system 500 is then able to determine a rough location of the advanced material handling vehicle within the warehouse based on images taken from one or more cameras 512.

The visual RTLS aspect of the perception system 500 uses a combination of the systems and subsystems described above to not only detect and identify objects, but also to detect the position of the objects relative to each other by evaluating the raw image data with the location data from the one or more cameras 512 (or sensors) and utilizing a memory component to track and monitor the status and movement of certain objects. The visual RTLS system can also utilize an aggregate of the information available from the systems and subsystems of the perception system 500 to filter and cluster data points from the raw data, to determine which feature to use for positioning and location determination. The combined object detection and positioning information obtained and used in the visual RTLS system can be exported or otherwise transmitted for reporting and tracking. In this way, the visual RTLS system can be used not only for real-time operator safety and guidance, but also for warehouse management and inventory logistic applications.

Specific embodiments of an advanced material handling vehicle according to the present invention have been described for the purpose of illustrating the manner in which the invention can be made and used. It should be understood that the implementation of other variations and modifications of this invention and its different aspects will be apparent to one skilled in the art, and that this invention is not limited by the specific embodiments described. Features described in one embodiment can be implemented in other embodiments. The subject disclosure is understood to encompass the present invention and any and all modifications, variations, or equivalents that fall within the spirit and scope of the basic underlying principles disclosed and claimed herein.

What is claimed is:

1. A material handling vehicle comprising:
a mast moveably coupled to a body of the material handling vehicle;
a motor coupled to the body of the material handling vehicle;
a wheel coupled to the motor;
a perception system designed for real-time locating of the material handling vehicle, the perception system comprising:
a hardware subsystem including one or more sensors coupled to the body of the material handling vehicle and electrically connected to a processor, wherein the processor is configured to process sensor data collected from the hardware subsystem;
a task subsystem designed to perform one or more tasks of the perception system; and
a focus manager subsystem designed to determine a priority for the one or more tasks to be performed by the task subsystem.

2. The material handling vehicle of claim 1, further comprising an item subsystem for aggregating object features from the sensor data into defined items.

3. The material handling vehicle of claim 1, further comprising a multi-level localization system for identifying objects from the sensor data.

4. The material handling vehicle of claim 3, wherein the multi-level localization system further comprises a first localization level provided in the form of an Oriented FAST and Rotated BRIEF (ORB) feature matching module for object detection within a warehouse environment.

5. The material handling vehicle of claim 4, further comprising a second odometry level designed to analyze features identified within one or more image frames from a generated aggregate data set of the sensor data.

6. The material handling vehicle of claim 5, wherein the perception system determines one or more of a speed, distance, or location of the material handling vehicle based on an analysis of the second odometry level.

7. The material handling vehicle of claim 1, wherein the one or more sensors includes a camera.

8. The material handling vehicle of claim 1, wherein the one or more tasks of the task subsystem includes a vision location tracking task for detecting a location of the material handling vehicle relative to one or more identified features extracted from the sensor data.

9. A material handling vehicle comprising:
a lifting device moveably coupled to a body of the material handling vehicle;
an automation system for executing one or more automation tasks;
a perception system designed for real-time locating of the material handling vehicle, the perception system comprising:
one or more sensors coupled to the body of the material handling vehicle designed to collect sensor data,
a task subsystem designed to perform one or more tasks of the perception system, and
a vision location tracking task of the task subsystem including multi-level localization for object detection and location monitoring.

10. The material handling vehicle of claim 9, wherein the lifting device is provided in the form of a vertical mast.

11. The material handling vehicle of claim 9, wherein the one or more automation tasks of the automation system includes a hazard avoidance task.

12. The material handling vehicle of claim 9, wherein the one or more automation tasks of the automation system includes a collision avoidance task.

13. The material handling vehicle of claim 9, wherein the vision location tracking task is designed to monitor a location of the material handling vehicle relative to one or more features identified from the sensor data.

14. The material handling vehicle of claim 9, wherein the one or more sensors includes a camera designed to collect one or more image frames.

15. The material handling vehicle of claim 9, wherein the automation system executes the one or more automation tasks in response to the one or more tasks performed by the task subsystem.

16. A method for real-time location monitoring of a material handling vehicle using an advanced perception system, the method comprising:
collecting sensor data from one or more sensors of a hardware subsystem of the material handling vehicle;
processing the sensor data collected from the hardware subsystem;
identifying one or more tasks to be completed by a task subsystem based on the processed sensor data;
determining a priority for the one or more tasks using a focus manager subsystem; and
controlling the material handling vehicle to perform the one or more tasks based on the determined priority for the one or more tasks.

17. The method of claim 16, wherein the one or more sensors is provided in the form of a camera and the sensor data includes one or more image frames captured using the camera.

18. The method of claim 16, wherein processing the sensor data further includes detecting one or more objects from the sensor data and identifying the one or more objects.

19. The method of claim 16, wherein determining the priority for the one or more tasks further includes providing rules to create a hierarchy of priorities based on the sensor data received from the task subsystem.

20. The method of claim 16, further comprising:
capturing one or more image frames using a camera of the hardware subsystem;
processing the one or more image frames, wherein the processing includes steps of:
receiving the one or more image frames,
applying a gaussian blur,
resizing the one or more image frames,
converting a color spectrum of the one or more image frames,
applying a color filter to the one or more image frames, and
creating an image mask to the one or more image frames;
performing text recognition on the one or more image frames using edge detection; and
creating a bounding box around one or more detected objects from the one or more image frames.
